(19) United States
(12) Patent Application Publication
(10) Pub. No.: US 2025/0319501 A1
(43) Pub. Date: Oct. 16, 2025

(54) AIR-BLOWING AND TRIMMING STRUCTURE OF EDGE BANDING MACHINE

(71) Applicant: OAV EQUIPMENT AND TOOLS, INC., TAICHUNG CITY (TW)

(72) Inventor: YEN-TSUNG CHANG, TAICHUNG CITY (TW)

(21) Appl. No.: 18/758,696

(22) Filed: Jun. 28, 2024

(30) Foreign Application Priority Data
Apr. 16, 2024 (TW) 113114186

(51) Int. Cl. B08B 5/02; B27B 5/04

(52) U.S. Cl. CPC B08B 5/023; B27B 5/04

(57) ABSTRACT

An air-blowing and trimming structure of the edge banding machine includes a mounting base, a scraper base, and a scraper. The mounting base has an air inlet connected to a pressure source, an airway connected to the air inlet, and an air outlet groove connected to the airway. The scraper base is attached to the mounting base and has a vent connected to the air outlet groove of the mounting base. The scraper is attached to the scraper base and located at one side of the vent of the scraper base. By blowing air from the vent, the trimmed edge material is directed towards a dust collector, thereby enhancing the dust collection efficiency and solving the issue of poor dust collection in known trimming structure.

### BACKGROUND OF THE INVENTION

### 1. Field of the Invention

The present invention relates to edge banding machines and more particularly, to an air-blowing and trimming structure of an edge banding machine.

### 2. Description of the Related Art

A traditional edge banding machine typically relies on the dust hood to align with the waste discharge point and uses the suction generated by the motor to remove the waste. However, due to the configuration of the trimming device, the dust hood cannot be placed very close to the scraper base, such that when the suction of the dust collector is insufficient or when the suction is inadequate due to the dust collection drum being full, the waste trimmed by the trimming device cannot be completely removed. This often leads to the situation where the trimmed waste accumulates at the edge of the machine, which still needs improvement.

### SUMMARY OF THE INVENTION

It is one objective of the present invention to provide an air-blowing and trimming structure of an edge banding machine, which can blow the trimmed waste towards a dust collector to enhance the dust collection efficiency.

To attain the above objective, the air-blowing and trimming structure of the edge banding machine comprises a mounting base, a scraper base, and a scraper. The mounting base has an air inlet connected to a pressure source, an airway connected to the air inlet, and an air outlet groove connected to the airway. The scraper base is mounted to the mounting base and has a vent connected to the air outlet groove of the mounting base. The scraper is mounted to the scraper base and located at one side of the vent of the scraper base.

It can be seen from the above that by blowing air from the vent, the trimmed edge material is directed towards a dust collector, thereby enhancing the dust collection efficiency to achieve the purpose of the present invention.

Preferably, the scraper base can adjust its position relative to the mounting base to enable the vent not to be connected to the air outlet groove of the mounting base.

Preferably, the vent is two in number. One of the vents is connected to the air outlet groove of the mounting base, and the other of the vents is not connected to the air outlet groove of the mounting base.

Preferably, the vent is two in number. The scraper base can adjust its position relative to the mounting base to enable the two vents to be connected to the air outlet groove of the mounting base.

Preferably, the airway and the air outlet groove are provided at a top surface of the mounting base covered by a bottom surface of the scraper base.

Preferably, the scraper has an edge portion covering a part of the vent of the scraper base.

Preferably, the scraper base has a recess provided with two edges. The vent passes through one of the two edges.

Preferably, a connecting bolt is connected to a first connection hole of the mounting base and a second connection hole of the scraper base.

Preferably, an adjusting assembly is pivotally connected to the connecting bolt and mounted to the scraper base, such that the scraper base is adjusted by the adjusting assembly to be rotated relative to the mounting base.

Preferably, two adjusting bolts are provided at two sides of the adjusting assembly and abutted against two sides of the mounting base for adjusting the scraper base to be rotated relative to the mounting base.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a perspective view of an air-blowing and trimming structure of the present invention.

FIG. 2 is a top perspective view of the air-blowing and trimming structure of the present invention.

FIG. 3 is a top view of the air-blowing and trimming structure of the present invention.

FIG. 4 is a sectional view taken along line 4-4 of FIG. 3.

FIG. 5 is a sectional view taken along line 5-5 of FIG. 3.

FIG. 6 is a bottom perspective view of the air-blowing and trimming structure of the present invention.

FIG. 7 is a bottom view of the air-blowing and trimming structure of the present invention.

FIG. 8 is a perspective view of the mounting base provided by the air-blowing and trimming structure of the present invention.

FIG. 9 is another perspective view of the mounting base provided by the air-blowing and trimming structure of the present invention.

FIG. 10 is a top view of the mounting base provided by the air-blowing and trimming structure of the present invention.

FIG. 11 is a perspective view of the scraper base provided by the air-blowing and trimming structure of the present invention.

FIG. 12 is another perspective view of the scraper base provided by the air-blowing and trimming structure of the present invention.

FIG. 13 is a top view of the scraper base provided by the air-blowing and trimming structure of the present invention.

FIG. 14 is a perspective view of the scraper provided by the air-blowing and trimming structure of the present invention.

### DETAILED DESCRIPTION OF THE INVENTION

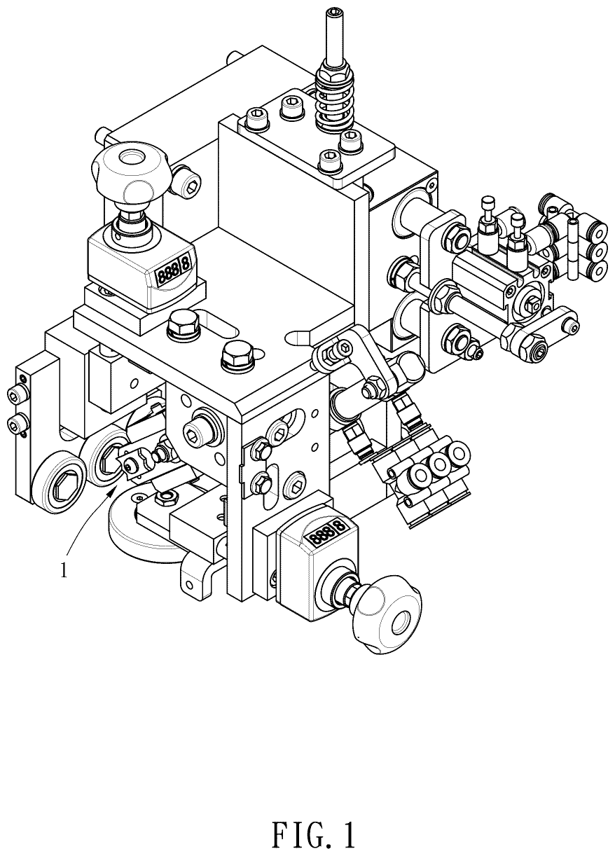

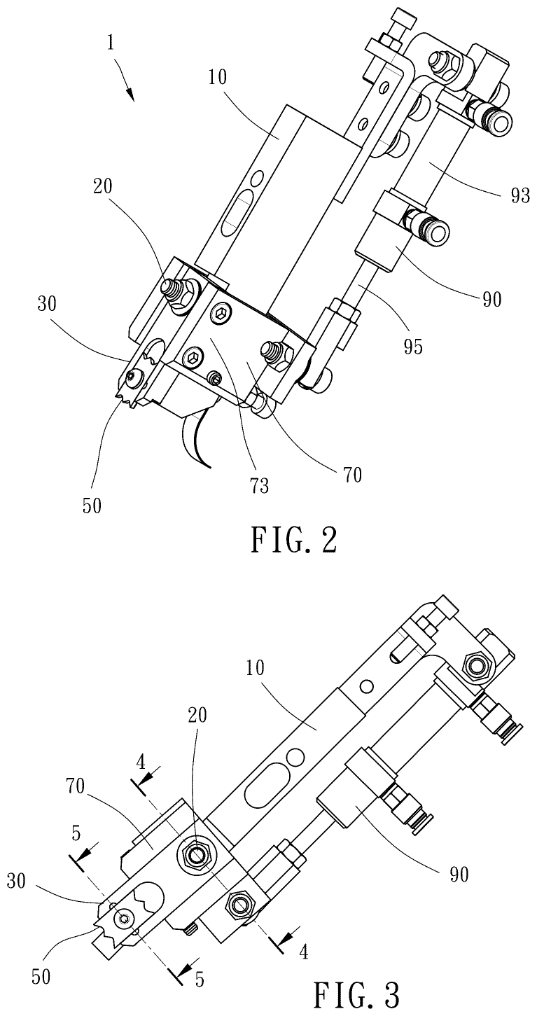

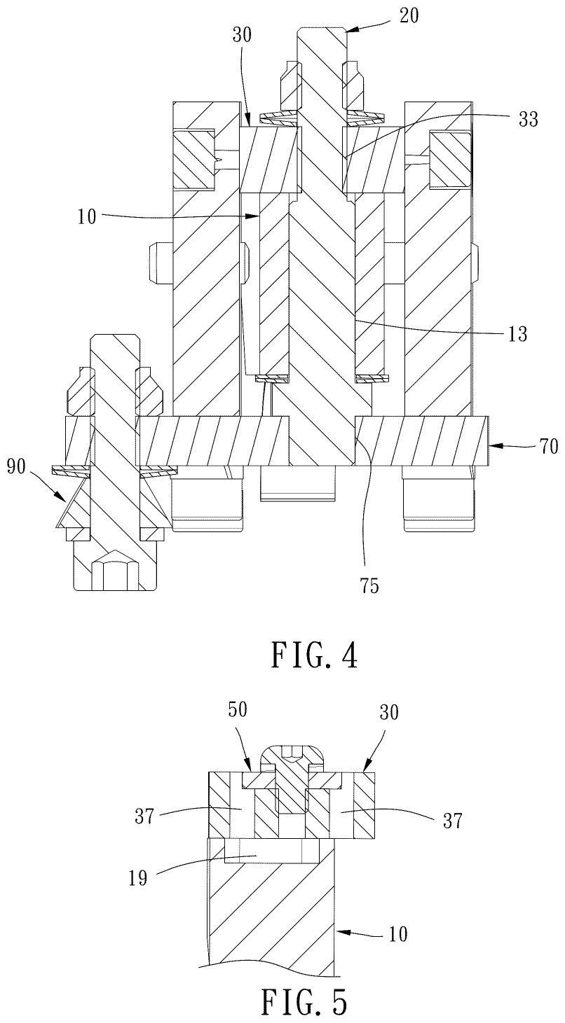

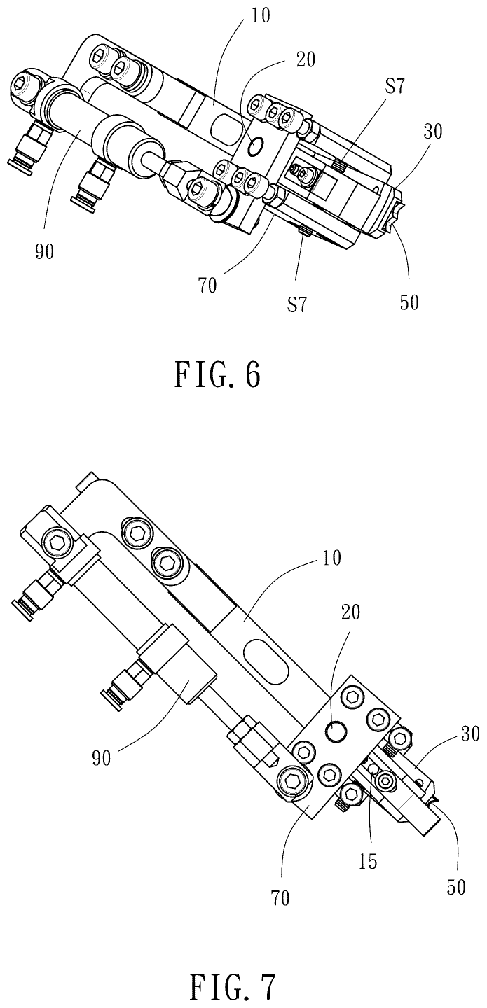

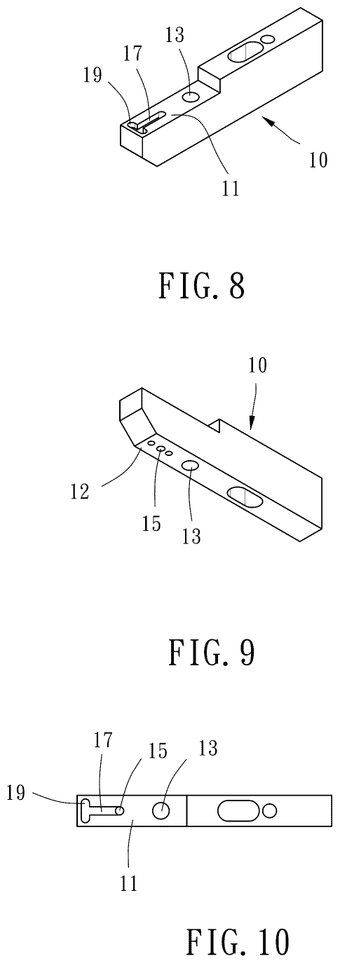

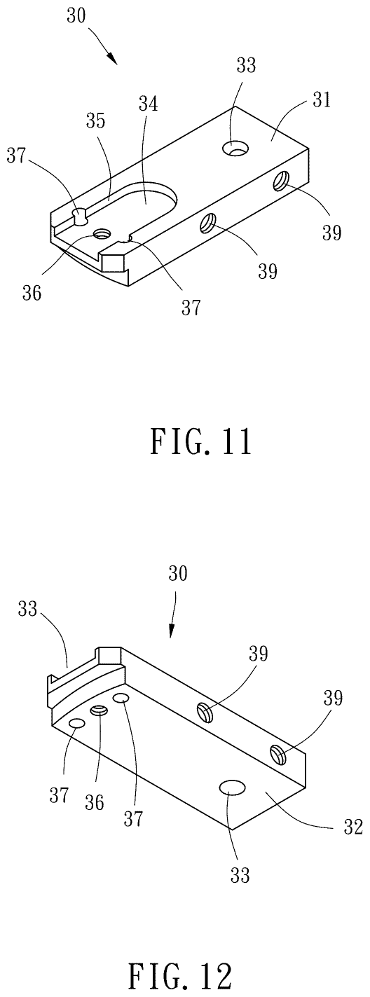

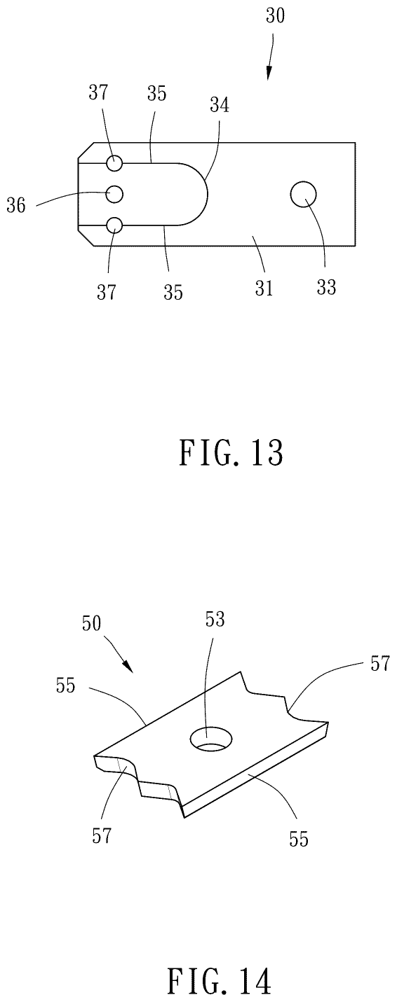

As shown in FIGS. 1-14, an air-blowing and trimming structure 1 of the present invention is installed in a trimming device of an edge banding machine for trimming a to-be-processed board. The to-be-processed board has a top surface and a lateral side. An edge band is attached to the lateral side of the to-be-processed board.

The air-blowing and trimming structure 1 comprises a mounting base 10, a connecting bolt 20, a scraper base 30, a scraper 50, an adjusting assembly 70, and a retractable assembly 90.

The mounting base 10 includes a top surface 11, a bottom surface 12, a first connection hole 13 passing through the top surface 11 and the bottom surface 12, an air inlet 15 formed from the bottom surface 12 toward the top surface 11, an airway 17 provided at the top surface 11 and connected to the air inlet 15, and an air outlet groove 19 provided at the top surface 11 and vertically connected to the airway 17.

The connecting bolt 20 is connecting to the first connection hole 13 of the mounting base 10 and equipped with an elastic washer.

The scraper base 30 is mounted to the mounting base 10 and connecting with the connecting bolt 20. The scraper base 30 includes a top surface 31, a bottom surface 32, a second connection hole 33, a recess 34, two edges 35, a first fixing hole 36, two vents 37, and four threaded holes 39. The second connection hole 33 passes through the top surface 31 and the bottom surface 32, and the second connection hole 33 is pivoted to the connecting bolt 20 (i.e., the mounting base 10 and the scraper base 30 are pivoted to each other) and equipped with an elastic washer and fastened with a nut. The recess 34 is formed at a front end thereof from the top surface 34. The two edges 35 are formed at the recess 34. The vents 37 are connected to the air outlet groove 19 of the mounting base and pass through the top and bottom surfaces 31, 32 and the edges 35. The threaded holes 39 are arranged at two lateral sides of the scraper base 30 in pairs.

The scraper 50 is installed in the recess 34 of the scraper base 30 and includes a second fixing hole 53 fastened to the first fixing hole 36 of the scraper base 30 through a bolt, two edge portions 55 abutted against the edges 35 of the scraper base 30 and each covering a part of the vent 37 of the scraper base 30, and two blade portions 57 for trimming the board.

The adjusting assembly 70 includes a scraper base connecting portion 73 and a third connection hole 75. The scraper base connecting portion 73 is connected to the scraper base 30 and threaded with the threaded hole 39 of the scraper base 30 through a bolt.

The retractable assembly 90 included a main body 93 and a retractable rod 95 provided in the main body 93 for driving the adjusting assembly 70 to move.

In accordance with the aforementioned structure, by providing an air pressure source to connect the air inlet 15 of the mounting base 10, the air generated by air pressure source flows to the air outlet groove 19 through the airway 17, and then blows out from the vents 37 of the scraper base 30, so that the air blows on the lateral side of the scraper 50.

In this embodiment, the scraper base 30 can adjust its position relative to the mounting base 10, so that one of the vents 37 communicates with the air outlet groove 19 of the mounting base 10, and the other of the vents 37 does not communicate with the air outlet groove 19 of the mounting base 10. This causes the air to blow on the left or right side of the scraper 50.

As such, by blowing air from the vent 37 on at least one lateral side of the scraper base 30, the trimmed edge material is directed towards a dust collector, thereby enhancing the dust collection efficiency to achieve the purpose of the present invention.

Further, since the air outlet groove 19 and the airway 17 are vertically connected with each other, various communication requirements between the air outlet groove 19 and the vents 37 can be adjusted to achieve the purpose of the present invention.

In addition to the above embodiment, the present invention can also be implemented as follows:

For example, the scraper base 30 can adjust its position relative to the mounting base 10 to allow the two vents 37 to communicate with the air outlet groove 19 of the mounting base 30, so that the air can blow out from the two vents 37.

Alternatively, the vent 37 of the scraper base 30 can be at least one in number. In addition, the scraper base 30 can adjust its position to allow the vent 37 not to communicate with the air outlet groove 19 of the mounting base 30.

Alternatively, the mounting base 10 and the scraper base 30 are not limited to be connected by the connecting bolt 20. They can be connected by using other structures.

Alternatively, the adjusting assembly 70 can be omitted, so that the mounting base 10 and the scraper base 30 can be directly fixed or adjusted without using the adjusting assembly 70.

Further, the retractable assembly 90 can be omitted, so that the adjusting assembly 70 can be manually adjusted or fixed.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An air-blowing and trimming structure of an edge banding machine, comprising:
a mounting base having an air inlet for connecting to a pressure source, an airway communicating with the air inlet, and an air outlet groove communicating with the airway;
a scraper base mounted to the mounting base and having a vent communicating with the air outlet groove of the mounting base; and
a scraper mounted to the scraper base and located at one side of the vent of the scraper base.

2. The air-blowing and trimming structure of the edge banding machine as claimed in claim 1, wherein a position of the scraper base is adjustable relative to the mounting base to enable the vent not to be connected to the air outlet groove of the mounting base.

3. The air-blowing and trimming structure of the edge banding machine as claimed in claim 1, wherein the vent is two in number; one of the vents is connected to the air outlet groove of the mounting base, and the other of the vents is not connected to the air outlet groove of the mounting base.

4. The air-blowing and trimming structure of the edge banding machine as claimed in claim 1, wherein the vent is two in number; a position of the scraper base is adjustable relative to the mounting base to enable the two vents to be connected to the air outlet groove of the mounting base.

5. The air-blowing and trimming structure of the edge banding machine as claimed in claim 1, wherein the airway and the air outlet groove are provided at a top surface of the mounting base covered by a bottom surface of the scraper base.

6. The air-blowing and trimming structure of the edge banding machine as claimed in claim 1, wherein the scraper has an edge portion covering a part of the vent of the scraper base.

7. The air-blowing and trimming structure of the edge banding machine as claimed in claim 1, wherein the scraper base has a recess provided with two edges; the vent passes through one of the edges.

8. The air-blowing and trimming structure of the edge banding machine as claimed in claim 1, further comprising a connecting bolt connected to a first connection hole of the mounting base and a second connection hole of the scraper base.

9. The air-blowing and trimming structure of the edge banding machine as claimed in claim 8, further comprising an adjusting assembly pivotally connected to the connecting bolt and mounted to the scraper base, such that the scraper base is adjusted by the adjusting assembly to be rotated relative to the mounting base.

10. The air-blowing and trimming structure of the edge banding machine as claimed in claim 9, further comprising two adjusting bolts provided at two sides of the adjusting assembly and abutted against two sides of the mounting base for adjusting the scraper base to be rotated relative to the mounting base.
